(19) United States
(12) Patent Application Publication
(10) Pub. No.: US 2012/0021281 A1
(43) Pub. Date: Jan. 26, 2012

(54) CURRENT CARRIER FOR AN ENERGY STORAGE DEVICE

(75) Inventors: Kurtis C. Kelley, St. George, ME (US); Charles F. Ostermeier, Slater, IA (US)

(73) Assignee: FIREFLY INTERNATIONAL ENERGY GROUP, INC., Peoria, IL (US)

(21) Appl. No.: 13/162,432

(22) Filed: Jun. 16, 2011

Related U.S. Application Data
(62) Division of application No. 11/887,402, filed on Sep. 28, 2007.

(30) Foreign Application Priority Data
Mar. 29, 2006 (US) PCT/US2006/011448

(51) Int. Cl. H01M 4/66; H01M 4/68; H01M 2/26

(52) U.S. Cl. 429/211

(57) ABSTRACT

A current collector plate for an energy storage device comprising a first current collector, a bonding layer connected to the first current collector; and, at least one current carrier disposed at least partially between the first current collector and the bonding layer.

### RELATED APPLICATIONS

This application claims priority to U.S. Provisional Patent Application No. 60/666,771, filed on Mar. 31, 2005.

### BACKGROUND OF THE INVENTION

1. Field of the Invention

This invention relates generally to a current conductors and, more particularly, to a current carrier for an energy storage device.

Lead acid batteries are known to include at least one positive current collector, at least one negative current collector, current carriers connecting the various battery components together, chemically active paste on the current collectors, and an electrolytic solution including, for example, sulfuric acid (H₂SO₄) and distilled water. Ordinarily, both the positive and negative current collectors in a lead acid battery are constructed from lead. The role of these lead current collectors is to transfer electric current to and from the battery terminals through internal current carriers during the discharge and charging processes. Lead current collectors are suitable for effectively collecting and transferring current to the current carriers.

Lead, however, is a dense material. Therefore, current collectors made of lead significantly add to the overall weight of conventional lead acid batteries.

Further, a notable limitation on the durability of lead acid batteries is caused by corrosion of lead-based positive current collectors and current carriers. Once the sulfuric acid electrolyte is added to the battery and the battery is charged, the positive current collectors and current carriers are continually subjected to corrosion due to exposure to sulfuric acid and to the anodic potentials of the positive plate (i.e., the positive current collector together with the chemically active paste). One of the most damaging effects of this corrosion is volume expansion. Particularly, as the lead current collectors and current carriers corrode, lead dioxide is formed from the lead source metal of the current collector and current carriers. This lead dioxide corrosion product has a greater volume than the lead source material consumed to create the lead dioxide. Corrosion of the lead source material and the ensuing increase in volume of the lead dioxide corrosion product is known as volume expansion.

Volume expansion induces mechanical stresses on corroding elements that deform and stretch the current collectors and carriers. At a total volume increase of the current collector of approximately 4% to 7%, the current collector may fracture. As a result, battery capacity drops, and eventually, the battery will reach the end of its service life. Further, such a fracture of a current carrier can prevent current from flowing to or from a particular current collector. At advanced stages of corrosion, internal shorting within the current collector and rupture of the cell case can occur. Both of these corrosion effects may lead to failure of one or more of the cells within the battery.

2. Related Art

One method of extending the service life of a lead acid battery is to increase the corrosion resistance of the battery elements. Several methods have been proposed for inhibiting the corrosion process in lead acid batteries. Because carbon does not oxidize at the temperatures at which lead acid batteries generally operate, some of these methods have involved using carbon in various forms to slow or prevent the detrimental corrosion process in lead acid batteries. For example, U.S. Pat. No. 5,512,390 (hereinafter the '390 patent) discloses a lead acid battery that includes current collectors made from graphite plates instead of lead. The graphite plates have sufficient conductivity to function as current collectors, and they are more corrosion resistant than lead. Substituting graphite plates for the lead current collectors may, therefore, lengthen the life of a lead acid battery.

While the battery of the '390 patent may potentially offer a lengthened service life as a result of reduced corrosion at the positive plate, the graphite plates of the '390 patent are problematic. For example, the graphite plates of the '390 patent are dense, flat sheets of material each having a relatively small amount of surface area. Unlike lead electrode plates of a conventional lead acid battery, which are generally patterned into a grid-like structure to increase the available surface area of the plates, the graphite plates of the '390 patent are smooth sheets with no patterning. In lead acid batteries, an increase in surface area of the current collector may increase the specific energy of the battery and, therefore, may translate into improved battery performance. More surface area on the current collectors may also lead to a reduction in the time required for charging and discharging of the battery. The relatively small surface area of the graphite plates of the '390 patent results in poorly performing batteries that have slow charging speeds.

Additionally, the graphite plates of the '390 patent lack the toughness of lead current collectors. The dense graphite plates of the '390 patent are brittle and may fracture when subjected to physical shock or vibration. Such physical shock and vibration commonly occur in vehicular applications, for example. Any fracturing of the graphite plates would lead to the same problems caused by volume expansion of ordinary lead current collectors. Therefore, despite offering an increased resistance to corrosion compared to conventional lead current collectors, the brittle nature of the graphite plates of the '390 patent could actually result in battery service lives shorter than those possible through use of ordinary lead current collectors.

### SUMMARY OF THE INVENTION

One aspect of the present invention includes a current collector plate for an energy storage device. The current collector plate includes a first current collector and a bonding layer connected to the first current collector. At least one current carrier is disposed at least partially between the first current collector and the bonding layer.

Further areas of applicability of the present invention will become apparent from the detailed description provided hereinafter. It should be understood that the detailed description and specific examples, while indicating the preferred embodiment of the invention, are intended for purposes of illustration only and are not intended to limit scope of the invention.

### BRIEF DESCRIPTION OF THE DRAWINGS

The accompanying drawings, which are incorporated in and constitute a part of this specification, illustrate exemplary embodiments of the invention and, together with the written description, serve to explain the principles of the invention. In the drawings:

FIG. 1A is a pictorial representation of a current collector plate in accordance with an exemplary embodiment of the present invention;

FIG. 1B is a cross-sectional view of the current collector plate of FIG. 1A taken along the line 1B;

FIG. 2A is a pictorial representation of a current carrier in accordance with an exemplary embodiment of the present invention;

FIG. 2B is a pictorial representation of a current collector and a current carrier according to an exemplary embodiment of the present invention;

FIG. 3A is a pictorial representation of another current carrier in accordance with an exemplary embodiment of the present invention;

FIG. 3B is a pictorial representation of another current collector and current carrier according to an exemplary embodiment of the present invention;

FIG. 4 is a diagrammatic cut-away representation of a battery in accordance with an exemplary embodiment of the present invention.

### DETAILED DESCRIPTION OF THE PREFERRED EMBODIMENT

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that other embodiments may be utilized and that changes may be made without departing from the scope of the present invention. The following description is, therefore, not to be taken in a limited sense. Wherever possible, the same reference numbers are used throughout the drawings to refer to the same or like parts.

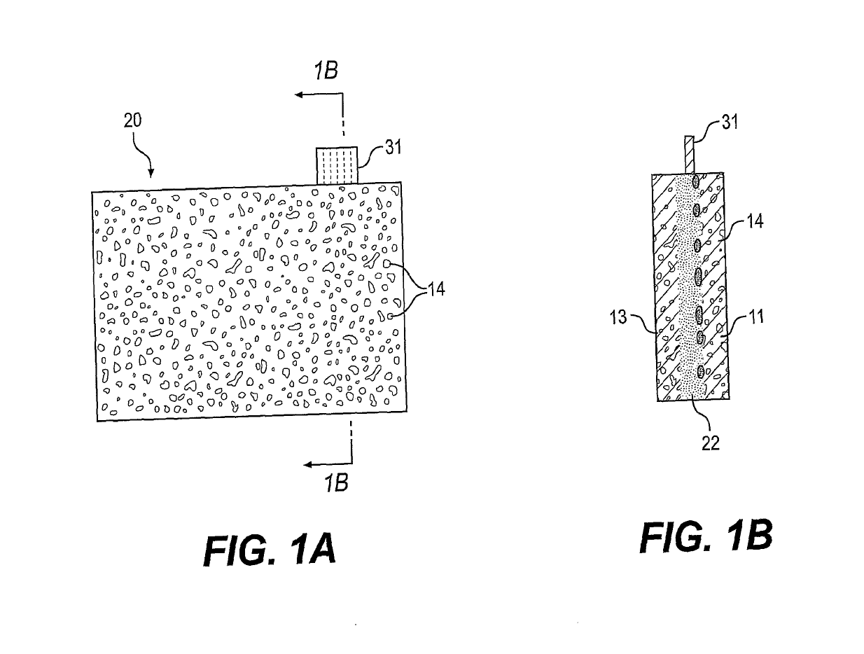

FIGS. 1A and 1B illustrate a current collector plate 20 consistent with an exemplary embodiment of the invention. Current collector plate 20 may include current collectors 11 and 13, which may be joined together by an optional bonding layer 22. While the exemplary embodiment shown in FIGS. 1A and 1B includes two current collectors 11 and 13, other embodiments of the invention may include only a single current collector 11 or 13. Alternatively, current collector plate 20 may include more than two current collectors. While current collectors 11 and 13 may be made from a variety of materials, including lead, one or both of current collectors 11 and 13 may be made from carbon foam. Carbon foam is lightweight and electrically conductive. In certain forms, carbon foam may have a density of less than about 0.6 gm/cm3 and offer sheet resistivity values of less than about 1 ohm/cm. Carbon is also resistant to corrosion, and therefore, current collector plate 20 may be used, for example, in the corrosive environment of a lead acid battery.

The disclosed foam material may include any carbon-based material having a reticulated pattern including a three-dimensional network of struts and pores. The foam may comprise either or both of naturally occurring and artificially derived materials. Graphite foam (i.e., a type of carbon foam) may also be used to form current collectors 11 and 13. One such graphite foam, under the trade name PocoFoam™, is available from Poco Graphite, Inc. The density and pore structure of graphite foam may be similar to carbon foam. A primary difference between graphite foam and carbon foam is the orientation of the carbon atoms that make up the structural elements of the foam. For example, in carbon foam, the carbon may be primarily amorphous. In graphite foam, however, much of the carbon is ordered into a graphite, layered structure. Because of the ordered nature of the graphite structure, graphite foam offers higher conductivity than carbon foam. PocoFoam™ graphite foam exhibits electrical resistivity values of between about 100:Σ/cm and about 400:Σ/cm.

Bonding layer 22 may attach current collectors 11 and 13 together and provide structural support for current collector plate 20. In certain embodiments, e.g., where current collectors 11 and 13 include carbon foam, current collectors 11 and 13 may include a network of pores 14. These pores may facilitate bonding of collectors 11 and 13 together by allowing the material of bonding layer 22 to penetrate one or both of current collectors 11 and 13. A variety of materials may be used as bonding layer 22. Bonding layer 22 may be either electrically conductive or non-conductive. Further, bonding layer 22 may include polymers (e.g., polypropylene), epoxies, metals, conductive polymers, ceramics, rubber, composites (e.g., carbon fibers dispersed in polymer matrix), and any combination thereof.

Current collector plate 20 may also include at least one current carrier 31 disposed at least partially between one of current collectors 11 and 13 and bonding layer 22. Current carrier 31 may be made from a conductive material and may electrically contact one or both of current collectors 11 and 13.

Current carrier 31 may also include a section that extends outside and away from the current collector to serve as a means for establishing an electrical connection between current collector plate 20 and external circuitry.

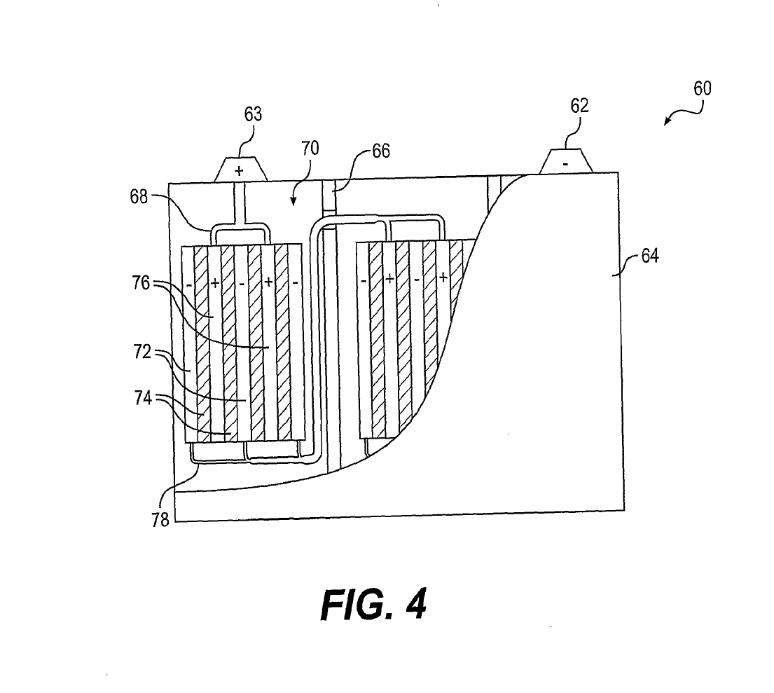

Further, this external section may have various different dimensional configurations depending on a particular application. For example, the external section of current carrier 31 may be formed as a tab-like projection, as shown in FIGS. 1A and 1B, or the external section of current carrier 31 may have a length sufficient to provide a substantial portion of the internal connections in a battery, as illustrated, for example by current carriers 68 and 78 shown in FIG. 4.

Current carrier 31 may include any conductive material. In certain embodiments of the invention, current carrier 31 may include at least one of boron, carbon, graphite, a conductive polymer, and any combination thereof. Further, current carrier 31 may include carbon fiber cloth, carbon fiber tape, unwoven carbon fiber cloth, a carbon fiber, a plurality of carbon fibers, a bundle of carbon fibers, graphite fiber cloth, graphite fiber tape, unwoven graphite fiber cloth, a graphite fiber, a plurality of graphite fibers, a bundle of graphite fibers, and any combination thereof.

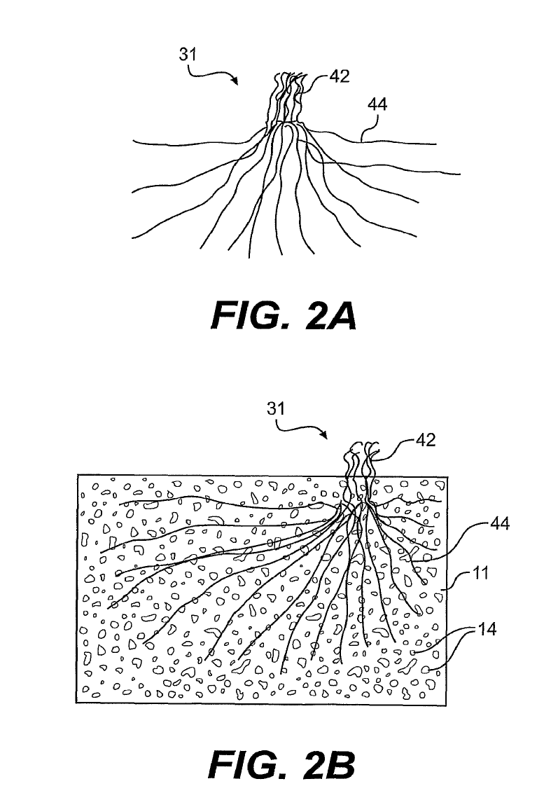

FIG. 2A illustrates an exemplary embodiment of the invention in which current carrier 31 includes a bundle 42 of carbon fibers 44. Bundle 42 may include any number of carbon fibers 44 (e.g, 1, 2, 10, 100, 1000, 10,000, or more). As the number of carbon fibers 44 present in current carrier 31 increases, the amount of current that current carrier 31 may carry also may increase. Carbon fibers 44 of bundle 42 may be graphite fibers, which may offer increased conductivity with respect to carbon fibers.

FIG. 2B illustrates an exemplary configuration of current carrier 31 with respect to current collector 11. For example, current carrier 31 may include a bundle 42 of carbon fibers 44. At least a portion of bundle 42 may extend beyond the edge of current collector 11. In another portion of bundle 42, for example, a portion that contacts current collector 11, carbon fibers 44 may be splayed apart in a fan-like, or other, pattern. Spreading apart carbon fibers 44, as shown in FIG. 2B, may provide a relatively even distribution of carbon fibers 44 on the surface of current collector 11. Such a distribution may help to maintain good electrical contact between current collectors 11 and/or 13 and current carrier 31 and minimize the distance that charge must travel through the current collectors 11, 13 before encountering current carrier 31. Additionally, arranging carbon fibers 44 in a splayed pattern, as shown in FIGS. 2A and 2B, may provide a certain amount of structural support to current collectors 11 and/or 13.

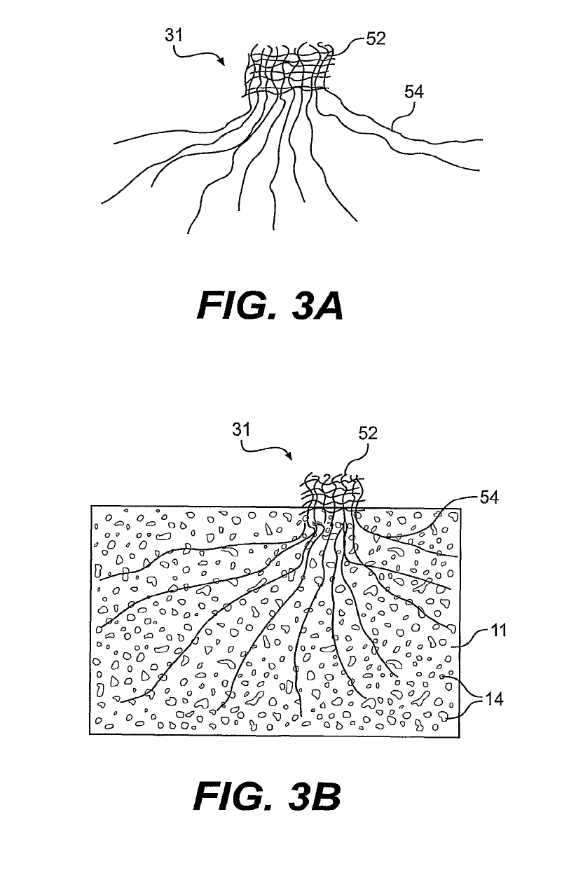

FIG. 3A illustrates another exemplary embodiment of the invention in which current carrier 31 includes a plurality of carbon fibers 54 at least partially woven together in the form of a woven cloth 52. Similar to bundle 42 of carbon fibers 44, carbon fibers 54 of woven cloth 52 may also comprise graphite fibers.

FIG. 3B illustrates another exemplary configuration of current carrier 31 with respect to current collector 11. For example, current carrier 31 may include woven cloth 52 formed of a plurality of carbon fibers 54. At least a portion of woven cloth 52 may extend beyond the edge of current collector 11. In another portion of woven cloth 52, for example, a portion that contacts current collector 11, carbon fibers 54 may be splayed apart in a fan-like pattern. Spreading apart carbon fibers 54, as shown in FIG. 3B, may provide a relatively even distribution of carbon fibers 54 on the surface of current collector 11. Similar to the embodiment shown in FIGS. 2A and 2B, arranging the carbon fibers in a splayed apart pattern, as illustrated by FIGS. 3A and 3B, may help to maintain good electrical contact between current collectors 11 and/or 13 and current carrier 31, and may provide structural support to current collectors 11 and/or 13.

Current carrier 31 may optionally include a metal coating. Such a metal coating may improve the durability of current carrier 31 and promote good electrical contact with both external circuitry and current collectors 11 and/or 13. A metal coating on current carrier 31 may also encourage lead wetting of current carrier 31. Such lead wetting may enable soldering of various conductors to current carrier 31 or the use of molded lead straps (e.g., where a portion of one or more of the current carriers is submerged in a mold containing molten lead, which is allowed to cool to form a lead strap) to connect to current carrier 31. While the metal coating may include any of a wide range of metals, in one exemplary embodiment, the metal coating may comprise silver.

Current collector plate 20 may also include a chemically active paste disposed on one or both of current collectors 11 and 13. Chemical reactions in the paste disposed on the current collectors enable storage and release of energy in a battery. The composition of this paste determines whether a particular current collector plate functions as either a positive or a negative plate.

Initially, the chemically active paste that is applied to the current collectors 11 and/or 13 of both the positive and negative current collector plates may be substantially the same in terms of chemical composition. For example, the paste may include lead oxide (PbO). Other oxides of lead may also be suitable. The paste may also include various additives including, for example, varying percentages of free lead, structural fibers, conductive materials, carbon, and extenders to accommodate volume changes over the life of the battery.

Once the chemically active paste is deposited on current collectors 11 and/or 13, the positive and negative current collector plates are formed. To create a positive current collector plate, the chemically active paste may optionally be cured at elevated temperatures and/or humidity levels to encourage growth of lead sulfate crystals within the paste. A negative current collector plate requires no curing. With the exception of an optional step of drying, the lead oxide paste may be left “as is” on the negative current collector plates. Once the positive and negative plates have been prepared, they may be assembled together to atm a battery.

FIG. 4 illustrates a battery 60 in accordance with an exemplary embodiment of the invention. Battery 60 includes a housing 64, negative terminal 62, and positive terminal 63. At least one cell 70 is disposed within housing 64. While only one cell 70 is necessary, multiple cells may be connected in series or in parallel to provide a desired total potential of battery 60. Each cell 70 may be separated from adjacent cells 70 by a cell separator 66.

Each cell 70 may be composed of one or more positive plates 76 alternated with one or more negative plates 72 and immersed in an electrolytic solution including, for example, sulfuric acid and distilled water. Plate separators 74 may be disposed between positive plates 76 and negative plates 72 to reduce or eliminate shorting between the positive and negative plates. Both positive plates 76 and negative plates 72 may include current collector plates 20 as illustrated, for example, in FIGS. 1A and 1B. The current collectors 11 and 13 included in the negative plates 72 and/or the positive plates 76 may include carbon foam or other types of current collectors known in the art.

Each cell 70 of battery 60 may include current carriers, such as current carriers 68 and current carriers 78 shown in FIG. 4. Current carriers 68 and 78 may be configured in a variety of different ways and may include any of a wide range of materials. For example, current carriers 68 and 78 may be configured similar to current carrier 31, as shown in any of FIGS. 1A, 1B, 2A, 2B, 3A, and 3B. Further, current carriers 68 and 78 may include any of the materials described above with respect to current carrier 31. In one exemplary embodiment of the invention, one or more of current carriers 68 and 78 include carbon fiber bundles, and more specifically, graphite fiber bundles. In yet another exemplary embodiment of the invention, one or more of current carriers 68 and 78 include woven carbon fiber cloth, and more specifically, woven graphite fiber cloth.

In each cell 70, all of positive plates 76 may be connected together via current carriers 68 or 78. Similarly, all of negative plates 72 may be connected together via current carriers 68 or 78. It should be noted, however, that other possible wiring configurations are possible for each cell and may even be more appropriate depending on a particular application. In an exemplary embodiment of the invention, cells 70 of battery 60 may be connected together in series such that the positive plates 76 of one cell 70 are connected to the negative plates 72 of an adjacent or another cell 70. Further, the positive current carriers of the cell at the highest potential may be connected to an electrical contact on the battery housing to form positive terminal 63. Similarly, the negative current carriers of the cell at the lowest potential may be connected to an electrical contact on the battery housing to faun negative terminal 62.

As a nomenclature issue, determining whether a particular current carrier is considered a positive current carrier or a negative current carrier depends on the cell with which a particular current carrier is compared. For example, a particular current carrier may be a positive current carrier with respect to one cell (i.e., the current carrier emanates from the positive plates of the cell), and the same current carrier may be a negative current carrier with respect to another cell (i.e., the current carrier emanates from the negative plates of the another cell). In FIG. 4, current carrier 78 is a negative current carrier with respect to cell 70. Current carrier 78, however, is also a positive current carrier with respect to the cell adjacent to cell 70.

The positive and negative current carriers of the current collector plates and cells of battery 60 may be connected together in a variety of different ways. For example, the current carriers may be soldered, clamped, braided, spliced, twisted, or any combination thereof in order to join two or more current carriers together. Further, one or more current carriers may be joined together using molded lead straps, tape, ties, nuts, clamps, or any other appropriate coupling device or method.

### INDUSTRIAL APPLICABILITY

The current collectors and current carriers of the present invention are useful in any of a wide variety of applications where materials with corrosion resistance, high surface area, electrical conductivity, or low weight would be desirable. In one possible application, the current collectors and current carriers of the present invention may serve as components of a current collector plate in a battery, such as a lead acid battery, for example. These current collectors and current carriers may support the chemically active components of the battery and promote the flow of current between components and terminals of the battery.

Because current collectors 11, 13 and current carriers 31, 68, 78 may include carbon, (e.g., carbon/graphite foam and carbon/graphite fibers) these elements may resist corrosion even when exposed to sulfuric acid and to anodic potentials of the positive plate in a lead acid battery. As a result, the battery may offer a significantly longer service life as compared to batteries without carbon/graphite foam current collectors and/or carbon/graphite current carriers.

Also, the carbon foam of the current collectors 11, 13 includes a network of pores 14, which may provide a large amount of surface area for each current collector 11, 13. Current collectors composed of carbon foam may exhibit more than 2000 times the amount of surface area provided by conventional lead current collectors. The large amount of surface area associated with current collectors 11, 13 may translate into batteries having large specific energy and power values. For example, because of the open cell, porous network and relatively small pore size of the carbon foam materials, the chemically active paste of the positive and negative plates is intimately integrated with the conductive carbon material of current collectors 11, 13. Therefore, electrons produced in the chemically active paste at a particular reaction site must travel only a short distance through the paste before encountering the conductive carbon foam of current collectors 11, 13. This current may then be carried by the plurality of splayed conductive fibers of current carrier 31, for example.

As a result, batteries with current collectors 11, 13 of carbon foam and current carriers 31 of carbon/graphite fibers may offer improved specific energy and power values. In other words, these batteries, when placed under a load, may sustain their voltage above a predetermined threshold value for a longer time than batteries including either lead current collectors or graphite plate current collectors with conventional current carriers. Also, these batteries may discharge more quickly than batteries including either lead current collectors or graphite plate current collectors.

The increased specific power values offered by batteries of the present invention also may translate into reduced charging times. Therefore, the batteries may be suitable for applications in which charging energy is available for only a limited amount of time. For instance, in vehicles, a great deal of energy is lost during ordinary braking. This braking energy may be recaptured and used to charge a battery of, for example, a hybrid vehicle. The braking energy, however, is available only for a short period of time (i.e., while braking is occurring). In view of their reduced charging times, the batteries of the present invention may provide an efficient means for storing such braking energy. The porous nature of the carbon foam current collectors also creates an improved substrate for retaining the chemically active paste of the energy storage device. By impregnating the paste into pores of the carbon foam current collectors, the paste is less likely to separate from the current collectors. This property is important in vehicle and other applications where vibration is common.

Further, by including current carriers composed of carbon fibers and current collectors of carbon foam, which has a density of less than about 0.6 g/cm3, a battery may weigh substantially less than batteries including either lead current collectors or graphite plate current collectors.

It will be apparent to those skilled in the art that various modifications and variations can be made in the described current carrier and energy storage device without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1-27. (canceled)

28. A current collector plate for an energy storage device, the current collector plate comprising:
a first collector;
a bonding layer connected to the first current collector;
at least one current carrier disposed at least partially between the first current collector and the bonding layer; and
a second current collector connected to the bonding layer.

29. The current collector plate of claim 28, wherein at least one of the first current collector and second current collector is carbon foam.

30. The current collector plate of claim 28, wherein at least one current carrier includes at least one of boron, carbon, and a conductive polymer.

31. The current collector plate of claim 28, wherein at least one current carrier includes at least one of carbon fiber cloth, carbon fiber tape, unwoven carbon fiber cloth, a carbon fiber, a plurality of carbon fibers, and a bundle of carbon fibers.

32. The current collector plate of claim 28, wherein at least one current carrier includes a bundle of carbon fibers.

33. The current collector plate of claim 32, wherein the bundle of carbon fibers includes a first section disposed between the first current collector and the bonding layer, and a second section that protrudes from the current collector plate.

34. The current collector plate of claim 33, wherein at least a portion of the carbon fibers in the first section are splayed apart.

35. The current collector plate of claim 31, wherein at least one current collector includes carbon fiber cloth, and the carbon fiber cloth includes a first section disposed between the first current collector and the bonding layer, and a second section that protrudes from the current collector plate.

36. The current collector plate of claim 35, wherein at least a portion of the carbon fiber cloth in the second section includes a metal coating and the bonding layer includes a polymer.

37. The current collector plate of claim 36, wherein at least a portion of the fibers in the carbon fiber cloth are splayed apart.
